(19) United States
(12) Patent Application Publication
(10) Pub. No.: US 2007/0199020 A1
(43) Pub. Date: Aug. 23, 2007

(54) Portable device capable of receiving broadcasts, operating method of the portable device, and computer-readable recording medium storing computer program to execute the operating method

(75) Inventors: Joung-youl Kim, Seoul (KR); Young-Il Park, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/582,533

(22) Filed: Oct. 18, 2006

(30) Foreign Application Priority Data
Feb. 18, 2006 (KR) 2006-15942

(51) Int. Cl. H04N 7/16; G06F 3/00; H04N 5/445

(52) U.S. Cl. 725/39; 725/62

(57) ABSTRACT

A portable device capable of receiving broadcasts which can facilitate channel search and selection operations, a scheduled recording operation, and a scheduled recording confirmation operation, a method of operating the portable device, and a computer-readable recording medium storing a computer program for executing the method, the portable device including a sub-display unit to display channel search information when a main power of the portable device is off.

### CROSS-REFERENCE TO RELATED APPLICATION

This application claims all benefits accruing under 35 U.S.C. §119 from Korean Patent Application No. 2006-15942, filed on Feb. 18, 2006, in the Korean Intellectual Property Office, the disclosure of which is incorporated herein in its entirety by reference.

### BACKGROUND OF THE INVENTION

1. Field of the Invention

Aspects of the present invention relate to a portable device capable of receiving broadcasts, a method of operating the portable device, and a computer-readable recording medium storing a computer program to execute the method.

2. Related Art

In accordance with the diversification of functions of portable devices, such as laptop computers, mobile phones, and personal digital assistants (PDAs), portable devices capable of receiving broadcasts of multimedia, such as radio, TV, and data, from digital multimedia broadcasting (DMB) and digital audio/video broadcasting (DAB)/(DVB) systems have been developed. DMB can be classified as terrestrial DMB (T-DMB) and satellite DMB (S-DMB) according to the transmission means (ground wave or satellite transmission), and is based on the digital audio broadcast (DAB) standard. DVD for handheld devices (DVB_H) is based on the European broadcast standard.

During searching and selecting one or more broadcast channels (multimedia/mobile TV), if a main power of a conventional portable device is turned off, a user must turn the main power on and then refer to electronic program guide (EPG) information displayed by a main display unit of the portable device.

Accordingly, if the main power of the conventional portable device is turned off, broadcast channel search and selection operations can be very burdensome. In addition, given the fact that the power consumption of a main display unit of a portable device accounts for much of the power consumption of the portable device, the conventional portable device generally consumes an abundance of power by using the main display unit when performing broadcast channel search and selection operations.

Moreover, when the main power of the conventional portable device is turned on, the power is supplied to all of the components of the conventional portable device, regardless of the type of service to be performed. However, some of the components of a conventional portable device may not be utilized depending on the type of service used by a user, thus further leading to a wasteful power consumption. For example, when a user searches through a plurality of radio channels and chooses one of the radio channels, a main display unit of a portable device may be unnecessary. However, as described above, when the main power of the conventional portable device is turned on, the main display unit of the conventional portable device is automatically supplied with power. Therefore, the conventional portable device may consume unnecessary power depending on the type of service used by a user.

### SUMMARY OF THE INVENTION

Aspects of the present invention provide a portable device capable of receiving broadcasts which can facilitate channel search and selection operations while reducing power consumption, a method of operating the portable device, and a computer-readable recording medium storing a computer program to execute the method.

Aspects of the present invention also provide a portable device capable of receiving broadcasts which can facilitate a scheduled recording operation and a scheduled recording confirmation operation while reducing power consumption, a method of operating the portable device, and a computer-readable recording medium storing a computer program to execute the method.

In accordance with an embodiment of the present invention, there is provided a portable device capable of receiving broadcasts comprising: a tuner which receives a broadcast signal; a sub-display unit which displays channel search information based on an electronic program guide (EPG) information included in the broadcast signal; a control signal reception unit which receives a control signal to control an operation of the sub-display unit; a power supply unit which supplies power to the portable device; and a control unit which, when a main power of the portable device is turned off, controls the power supply unit to supply power to the tuner, the sub-display unit, and the control signal reception unit.

In accordance with another embodiment of the present invention, there is provided a portable device capable of receiving broadcasts comprising: a tuner which receives a broadcast signal; a channel module which detects EPG information from the broadcast signal and outputs the EPG information; a storage unit which stores the EPG information; a sub-display unit which displays channel search information based on the EPG information; a control signal reception unit which receives a control signal for controlling an operation of the sub-display unit; a power supply unit which supplies power to the portable device; and a control unit which, when a main power of the portable device is turned off, controls the power supply unit to supply power to the tuner, the channel module, the storage unit, the sub-display unit, and the control signal reception unit.

In accordance with yet another embodiment of the present invention, there is provided a method of operating a portable device capable of receiving broadcasts which comprises a sub-display unit installed on an exterior surface of the portable device. Such a method comprises: supplying power to one or more components of the portable device used to drive the sub-display unit when a main power of the portable device is turned off; and supplying power to one or more components of the portable device used to output a signal received via a chosen channel, when the channel is chosen with reference to channel search information displayed by the sub-display unit.

According to an aspect of the present invention, such a method may further comprise controlling operations of the components used to output a signal received via the chosen channel.

According to an aspect of the present invention, such a method may further comprise storing information regarding the broadcast requested to be scheduled to be recorded if a request for a scheduled recording of the broadcast is submitted with reference to the channel search information displayed by the sub-display unit.

According to an aspect of the present invention, such a method may further comprise enabling the sub-display unit to display information regarding one or more broadcasts scheduled to be recorded if a scheduled recording confirmation request is submitted when the sub-display unit displays the channel search information.

According to another aspect of the present invention, there is provided a computer-readable recording medium storing a computer program to execute a method of operating a portable device capable of receiving broadcasts which comprises a sub-display unit installed on an exterior surface of the portable device, the computer-readable recording medium comprising: code which supplies power to one or more components of the portable device used to drive the sub-display unit when a main power of the portable device is turned off; and code which, when a channel is chosen with reference to channel search information displayed by the sub-display unit, supplies power to one or more components of the portable device used to output a signal received via the chosen channel.

Additional aspects and/or advantages of the invention will be set forth in part in the description which follows and, in part, will be obvious from the description, or may be learned by practice of the invention.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram of a portable device capable of receiving broadcasts according to an embodiment of the present invention;

FIGS. 2A and 2B are diagrams illustrating the installation of a sub-display unit illustrated in FIG. 1 on a notebook computer according to an embodiment the present invention;

FIG. 3 is a block diagram of a portable device capable of receiving broadcasts according to another embodiment of the present invention;

FIG. 4 is a block diagram of a portable device capable of receiving broadcasts according to yet another embodiment of the present invention;

FIG. 5 is a flowchart illustrating a method of operating a portable device capable of receiving broadcasts according to an embodiment of the present invention; and

FIG. 6 is a flowchart illustrating a method of operating a portable device capable of receiving broadcasts according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

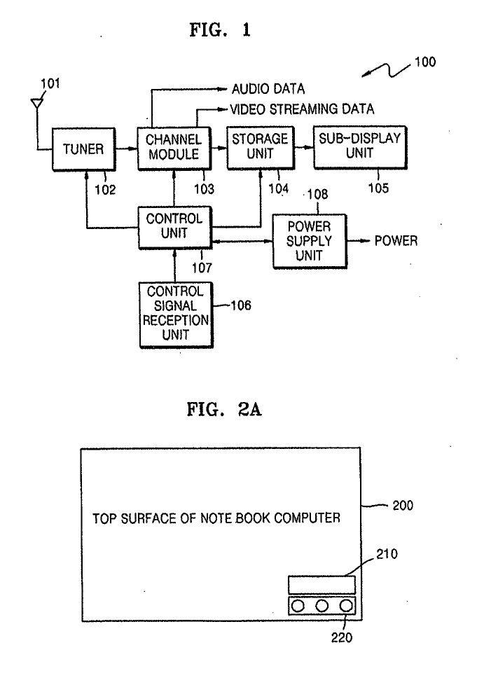

FIG. 1 is a block diagram of a portable device 100 capable of receiving broadcasts according to an embodiment of the present invention. Such a portable device can be a mobile phone, a laptop, and other mobile devices. Referring to FIG. 1, the portable device 100 may include an antenna 101, a tuner 102, a channel module 103, a storage unit 104, a sub-display unit 105, a control signal reception unit 106, a control unit 107, and a power supply unit 108.

The tuner 102 receives a broadcast signal via the antenna 101. The broadcast signal can include, but not limited to, a signal of a broadcast, such as a terrestrial Digital Multimedia Broadcast (T-DMB), a satellite DMB (S-DMB), and a Digital Video Broadcasting for Handheld (DVB_H).

The channel module 103 divides the broadcast signal into audio data (or Digital Audio Broadcast “DAB” data), video streaming data, and packet data, and outputs the audio data, the video streaming data, and the packet data. The packet data can include electronic program guide (EPG) information

The storage unit 104 stores the packet data output by the channel module 103. The packet data stored in the storage unit 104 can be defined as the EPG information, or can include EPG information included in a plurality of data. If a user submits a request for a scheduled recording of a predetermined broadcast with reference to information displayed by the sub-display unit 105, the storage unit 104 may store a scheduled recording information (or a reservation recording information) regarding the predetermined broadcast.

When a main power of the portable device 100 is turned off, the sub-display unit 105 displays channel search information specifying a plurality of broadcasts which can be received by the portable device 100 based on the EPG information stored in the storage unit 104. Also, when the user submits a scheduled recording confirmation request when the main power of the portable device 100 is turned off, the sub-display unit 105 may display the scheduled recording information regarding one or more broadcasts scheduled to be recorded, and the scheduled recording information may, although not necessarily, be stored in the storage unit 104.

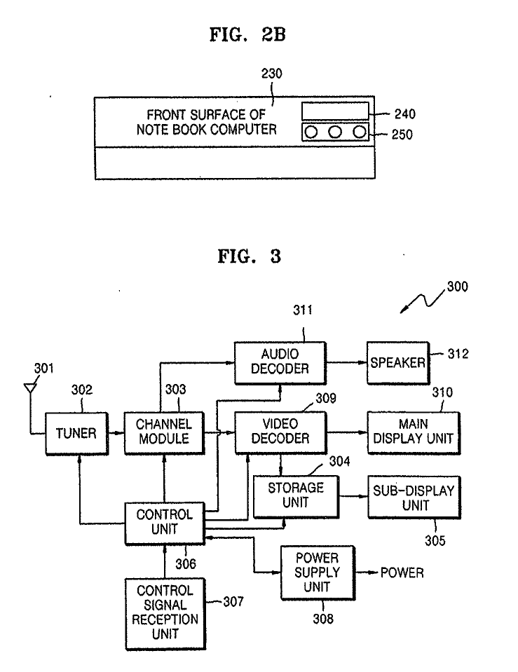

If the portable device 100 is a laptop or a notebook computer, the sub-display unit 105 may be provided on a top surface 200 of the notebook computer, as illustrated in FIG. 2A, or may, although not necessarily, be installed on a front surface 230 of the notebook computer, as shown in FIG. 2B. However, such a sub-display unit 105 may be installed on any surface of the notebook computer, and is not limited to the surface shown in FIGS. 2A-2B. Referring to FIG. 2A, reference numeral 210 indicates the sub-display unit 105 shown in FIG. 1. Referring to FIG. 2B, reference numeral 240 indicates the sub-display unit 105 shown in FIG. 1. Referring to FIG. 2A, reference numeral 220 indicates a button unit which comprises a plurality of buttons to control an operation of the sub-display unit 210. Referring to FIG. 2B, reference numeral 250 indicates the button unit which comprises the plurality of buttons to control the operation of the sub-display unit 240. However, it is understood that the present invention is not limited to the button unit to control the operation of the sub-display unit, and other methods may be used to control the operation of the sub-display unit, such as a touch-screen sub-display unit or an external controller.

The control signal reception unit 106 receives a control signal to control the operation of the sub-display unit 105 and provides the control signal to the control unit 107. When the control signal is generated by manipulating the buttons of the button unit 220 and 250 illustrated in FIGS. 2A and 2B, the control signal reception unit 106 monitors how the buttons of the button unit 220 and 250 have been manipulated and provides the results of the monitoring to the control unit 107.

Also, the control signal reception unit 106 may receive a selection signal specifying broadcast information which is chosen from the EPG information displayed by the sub-display unit 105 and indicates a request for the scheduled recording of the predetermined broadcast. The control signal reception unit 106 may receive a scheduled recording confirmation signal indicating whether to display the scheduled recording information stored in the portable device 100, via the sub-display unit 105. It is understood that the selection signal and the scheduled recording confirmation signal may be received via the button unit 220 and 250, or other means, such as the manipulation of the touch screen, according to an aspect of the present invention. Furthermore, the control signal reception unit 106 may receive a remote control signal to control the operation of the sub-display unit 105 from a remote device.

When the main power of the portable device 100 is turned off, the control unit 107 controls the power supply unit 108 to supply power to the tuner 102, the channel module 103, the storage unit 104, the sub-display unit 105, and the control signal reception unit 106 so that the tuner 102, the channel module 103, the storage unit 104, the sub-display unit 105, and the control signal reception unit 106 operate. Therefore, even when the main power of the portable device 100 is turned off, the EPG information included in a broadcast signal received by the tuner 102 can, although not necessarily, be stored in the storage unit 104, and the sub-display unit 105 can display channel search information specifying a plurality of broadcasts that can be received by the portable device 100 based on the EPG information and a control signal transmitted by the control signal reception unit 106.

Even when the main power of the portable device 100 is turned off, the power supply unit 108 continues supplying power to the control unit 107. The power supply unit 108 supplies power to the tuner 102, the channel module 103, the storage unit 104, the sub-display unit 105, and the control signal reception unit 106 under the control of the control unit 107.

According to an aspect of the present invention, the portable device 100 may include the antenna 101, the tuner 102, the sub-display unit 105, the control signal reception unit 106, the control unit 107, and the power supply unit 108. That is, the portable device 100 does not necessarily include the storage unit 104 and/or the channel module 103, or when the main power of the portable device 100 is turned off, the power supply unit 108 does not supply power to the storage unit 104 or the channel module 103. When the portable device 100 does not include the storage unit 104 and/or the channel module 103, the sub-display unit 105 can display the channel search information specifying a plurality of broadcasts that can be received by the portable device 100 based on the EPG information included in a broadcast signal received by the tuner 102.

FIG. 3 is a block diagram of a portable device 300 capable of receiving broadcasts according to another embodiment of the present invention. Referring to FIG. 3, the portable device 300 may include an antenna 301, a tuner 302, a channel module 303, a storage unit 304, a sub-display unit 305, a control unit 306, a control signal reception unit 307, a power supply unit 308, a video decoder 309, a main display unit 310, an audio decoder 311, and a speaker 312.

The structures and operations of the tuner 302, the channel module 303, the sub-display unit 305, and the control signal reception unit 307 are respectively the same as the structures and operations of the tuner 102, the channel module 103, the sub-display unit 105, and the control signal reception unit 106 illustrated in FIG. 1.

The storage unit 304 may store the same types of information as the storage unit 104 illustrated in FIG. 1 except that the storage unit 304 may, although not necessarily, store decoded packet data provided by the video decoder 309, instead of non-decoded packet data. In other words, the storage unit 304 may store decoded EPG information.

The video decoder 309 receives video streaming data and packet data including EPG information from the channel module 303 and decodes the video streaming data and the packet data. Then, the video decoder 309 may transmit the decoded packet data (including the decoded EPG information) to the storage unit 304 and may transmit the decoded video streaming data to the main display unit 310. It is understood that the portable device may transmit the decoded video streaming data to an external display unit through a wired or wireless connection thereto.

When a main power of the portable device 300 is turned off, the control unit 306 controls the power supply unit 308 to supply power to the tuner 302, the channel module 303, the video decoder 309, the storage unit 304, the sub-display unit 305, and the control signal reception unit 307.

When a selection signal for an audio channel chosen by a user with reference to the EPG information displayed by the sub-display unit 305 is received, the control unit 306 controls the power supply unit 308 to supply power to the audio decoder 311 and drives the audio decoder 311.

Accordingly, the audio decoder 311 decodes audio data (or DAB data) transmitted by the channel module 303 and transmits the decoded audio data to the speaker 312.

The audio decoder 311 may be a DAB codec. The speaker 312 outputs the audio data received via the audio channel chosen by the user.

When a selection signal for a video channel chosen by the user, which includes video streaming data, is received with reference to the EPG information displayed by the sub-display unit 305, the control unit 306 may control the power supply unit 308 to supply power to the main display unit 310, and the video decoder 309 decodes the video streaming data. The control unit 306 receives the channel selection signal for the video channel including the video streaming data via the control signal reception unit 307. However, it is understood that the portable device may transmit the decoded video streaming data to an external display unit through a wired or wireless connection thereto, and therefore does not necessarily supply power to the main display unit.

The main display unit 310 displays the decoded video streaming data transmitted by the video decoder 309.

When a selection signal for an audio/video channel chosen by the user, which includes video streaming data and audio data, is received with reference to the EPG information displayed by the sub-display unit 305, the control unit 306 controls the power supply unit 308 to supply power to the main display unit 310 and the audio decoder 311.

According to an aspect of the present invention, the portable device 300 does not necessarily include the channel module 303 and the storage unit 304. When the portable device 300 does not include the channel module 303 and the storage unit 304, the audio decoder 311 decodes the audio data received by the tuner 302 and the video decoder 309 decodes the video streaming data and the EPG information received by the tuner 302. Then, the decoded video streaming data is transmitted to the main display unit 310, and the decoded EPG information is transmitted to the sub-display unit 305.

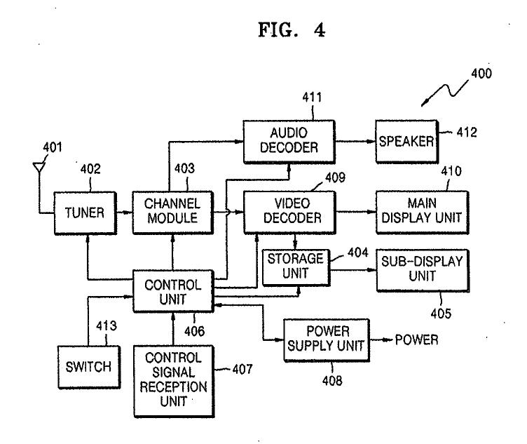

FIG. 4 is a block diagram of a portable device 400 capable of receiving broadcasts according to another embodiment of the present invention. Referring to FIG. 4, the portable device 400 may include an antenna 401, a tuner 402, a channel module 403, a storage unit 404, a sub-display unit 405, a control unit 406, a control signal reception unit 407, a power supply unit 408, a video decoder 409, a main display unit 410, an audio decoder 411, a speaker 412, and a switch 413.

The structures and operations of the antenna 401, the tuner 402, the channel module 403, the storage unit 404, the sub-display unit 405, the control signal reception unit 407, the power supply unit 408, the video decoder 409, the main display unit 410, the audio decoder 411, and the speaker 412 are respectively the same as the structures and operations of the antenna 301, the tuner 302, the channel module 303, the storage unit 304, the sub-display unit 305, the control signal reception unit 307, the power supply unit 308, the video decoder 309, the main display unit 310, the audio decoder 311, and the speaker 312 illustrated in FIG. 3.

An operating state of the switch 413 varies according to whether the portable device 400 is opened up or closed. For example, if the portable device 400 is a notebook computer, the portable device 400 is opened up when a main display panel is rotated from a closed position to an open position relative to a main body of the notebook computer. The operating state of the switch 413 is set to an off state when the notebook computer is opened up. On the other hand, when the notebook computer is closed, the operating state of the switch 413 is set to an on state. It is understood that the operating state of the switch 413 may be set in a different manner from the one set forth herein to indicate whether the portable device 400 is opened up or closed.

The control unit 406 monitors whether the operating state of the switch 413 is in an on state or an off state. If the results of the monitoring indicate that the portable device 400 is opened up and a selection signal for a channel including video streaming data is received, the control unit 406 controls the power supply unit 408 to supply power to the main display unit 410.

The portable device 400 does not necessarily include the channel module 403 and the storage unit 404. When the portable device 400 does not include the channel module 403 and the storage unit 404, the audio decoder 411 decodes the audio data received by the tuner 402 and the video decoder 409 decodes the video streaming data and the EPG information received by the tuner 402. Then, the decoded video streaming data is transmitted to the main display unit 410, and the decoded EPG information is transmitted to the sub-display unit 405.

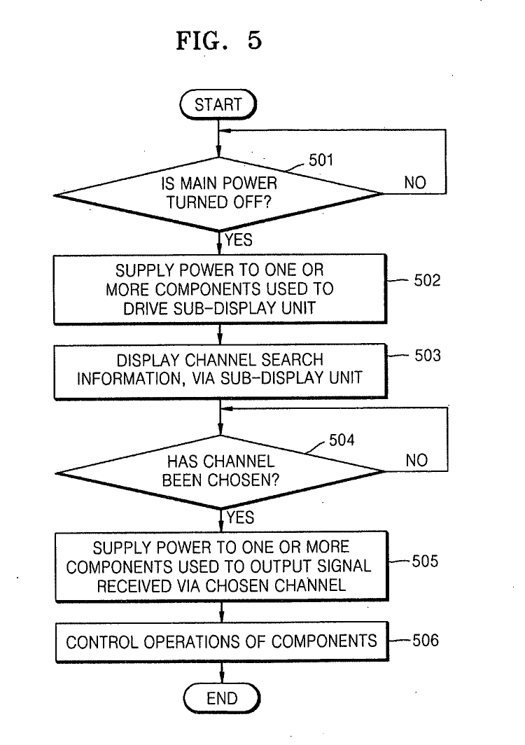

FIG. 5 is a flowchart illustrating a method of operating a portable device 300 capable of receiving broadcasts according to an embodiment of the present invention. Referring to FIGS. 3 and 5, if a main power of the portable device 300 is determined as being turned off in operation 501, power is supplied to one or more components of the portable device 300 which are used to drive the sub-display unit 305 in operation 502. The components used to drive the sub-display unit 305 may include the tuner 302, the channel module 303, the video decoder 309, the storage unit 304, the sub-display unit 305, the control signal reception unit 106, and the control unit 107.

In operation 503, channel search information which is generated based on EPG information that may be stored in the storage unit 304 is displayed by the sub-display unit 305.

When a channel is chosen in operation 504 with reference to the channel search information, power is supplied to one or more components of the portable device 300 which are used to output a signal received via the chosen channel in operation 505. If the chosen channel is an audio channel, the portable device 300 supplies power to the audio decoder 311. If the chosen channel is a video channel including video streaming data, the portable device 300 supplies power to the main display unit 310. If the chosen channel is an audio/video channel including video streaming data and audio data, the portable device 300 supplies power to the main display unit 310 and the audio decoder 311.

In operation 506, the portable device 300 controls the components used to output the signal received via the chosen channel by using the control unit 306.

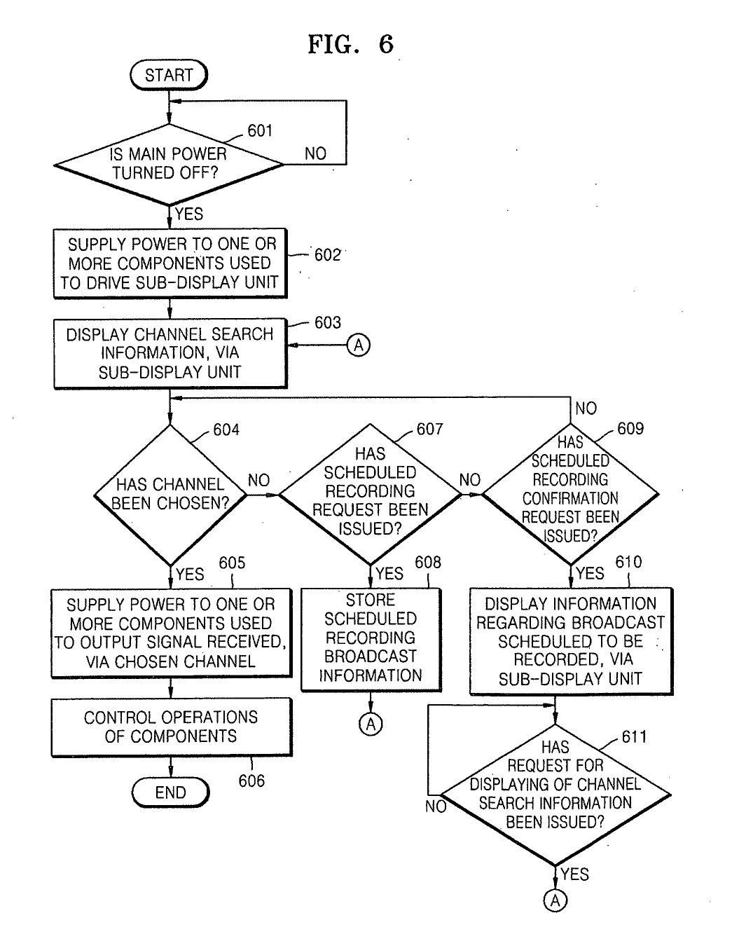

FIG. 6 is a flowchart illustrating a method of operating a portable device capable of receiving broadcasts according to another embodiment of the present invention. Referring to FIG. 6, operations 601 through 606 are respectively the same as operations 501 through 506 of FIG. 5, and thus their detailed descriptions will be omitted.

Referring to FIGS. 3 and 6, in operation 608, if it is determined in operation 607 that a request for a scheduled recording of a predetermined broadcast has been submitted with reference to channel search information displayed on the sub-display unit 305, the portable device 300 stores information regarding the predetermined broadcast requested for a scheduled recording in the storage unit 304, and the method returns to operation 603.

In operation 610, if it is determined in operation 609 that a scheduled recording confirmation request has been submitted with reference to the channel search information displayed on the sub-display unit 305, the portable device 300 displays via the sub-display unit 305 information regarding one or more broadcasts scheduled to be recorded and the information is stored in the storage unit 304. Thereafter, if a user submits a request to display the channel search information on the sub-display unit 305 when the sub-display unit 305 displays the information regarding the broadcast scheduled to be recorded, the method returns to operation 603.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner. Functional programs, code, and code segments needed to realize the present invention can be easily construed by one of ordinary skill in the art.

As described above, it is easy for the portable device capable of receiving broadcasts according to aspects of the present invention to search through a plurality of broadcast channels and choose one of the broadcast channels. In addition, the portable device capable of receiving broadcasts according to the present invention does not need to use a main display unit to search through a plurality of broadcast channels and choose one of the broadcast channels, thereby reducing power consumption.

Moreover, the portable device capable of receiving broadcasts according to the present invention performs a scheduled recording operation and a scheduled recording confirmation operation by using a sub-display unit, instead of using the main display unit, thereby maximizing user convenience and reducing power consumption.

Furthermore, a plurality of elements of the portable device capable of receiving broadcasts according to the present invention can be selectively supplied with power according to the type of channel chosen by a user, thereby reducing power consumption further.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the EPG information may be received via a wireless or wired network communication, a Bluetooth and/or infrared connection, and/or a docking of the portable device 100 to a unit that has the EPG information stored therein. In addition, the control unit 107, the channel module 103, and/or the control signal reception unit 106 can be implemented as a single control unit to perform all the functions as described for each of the separate units. Moreover, the audio decoder 311 and video decoder 309 can be implemented as a single unit to decode audio and/or video data. Furthermore, the computer-readable code, as described above, can also be stored in any machine-readable storage media, such as dynamic or static random access memories (DRAMs or SRAMs), erasable and programmable read-only memories (EEPROMs) and flash memories, magnetic disks, and other magnetic media, including tape. Also, the portable device may output streaming video data received in a broadcast signal to an external display device, and therefore not have to supply power to the main display unit. Accordingly, it is intended, therefore, that the present invention not be limited to the various example embodiments disclosed, but that the present invention includes all embodiments falling within the scope of the appended claims.

What is claimed is:

1. A portable device having a main display unit and capable of receiving broadcasts, the portable device comprising:
a tuner to receive a broadcast signal;
a sub-display unit to display channel search and selection information based on electronic program guide (EPG) information included in the broadcast signal;
a power supply unit to supply power to the portable device; and
a control unit to, when a main power of the portable device is turned off, control the power supply unit to supply power to the tuner and the sub-display unit.

2. The portable device as claimed in claim 1, further comprising:
an audio decoder to decode audio data received by the tuner,
wherein, when a selection signal for an audio channel is received, the control unit controls the power supply unit to supply power to the audio decoder and controls the audio decoder to decode the audio data.

3. The portable device as claimed in claim 2, further comprising:
a switch; and
a video decoder to decode video streaming data included in the broadcast signal and the EPG information,
wherein, when the main power of the portable device is turned off, the control unit controls the power supply unit to supply power to the video decoder, and when a selection signal for a channel including the video streaming data is received and the switch indicates that the portable device is opened up, the control unit controls the power supply unit to supply power to the main display unit to display decoded video streaming data.

4. The portable device as claimed in claim 1, further comprising:
a video decoder to decode video streaming data included in the broadcasting signal and the EPG information;
wherein, when the main power of the portable device is turned off, the control unit controls the power supply unit to supply power to the video decoder.

5. The portable device as claimed in claim 4, further comprising:
a switch, wherein, when a selection signal for a channel including the video streaming data is received and the switch indicates that the portable device is opened up, the control unit controls the power supply unit to supply power to the main display unit to display decoded video streaming data.

6. The portable device as claimed in claim 1, further comprising:
a switch, wherein, when a selection signal for a channel including video streaming data is received and the switch indicates that the portable device is opened up, the control unit controls the power supply unit to supply power to the main display unit to display the video streaming data.

7. The portable device as claimed in claim 1, further comprising a storage unit to store the EPG information, and wherein the sub-display unit displays the channel search information based on the EPG information stored in the storage unit or included in the broadcast signal.

8. The portable device as claimed in claim 7, wherein the storage unit stores requests for scheduled recordings of predetermined broadcasts, wherein the control unit controls the sub-display unit to display the requests for scheduled recordings.

9. The portable device as claimed in claim 1, further comprising a button unit comprising a plurality of control buttons, which enables a user to manipulate a channel search and selection on the sub-display unit.

10. The portable device as claimed in claim 1, wherein the sub-display unit comprises a touch-screen, which enables a user to manipulate a channel search and selection on the sub-display unit.

11. The portable device as claimed in claim 1, wherein the portable device is a notebook computer and the sub-display unit is provided on one of a top surface and front surface of the notebook computer.

12. A portable device capable having a main display unit and capable of receiving broadcasts, the portable device comprising:
a tuner to receive a broadcast signal;
a channel module to detect electronic program guide (EPG) information from the broadcast signal;
a storage unit to store the EPG information;
a sub-display unit to display channel search information based on the EPG information and provided on a surface of the portable device;
a control signal reception unit to receive a control signal to control an operation of the sub-display unit;
a power supply unit to supply power to the portable device; and
a control unit to, when a main power of the portable device is turned off, control the power supply unit to supply power to the tuner, the channel module, the storage unit, the sub-display unit, and the control signal reception unit.

13. The portable device as claimed in claim 12, wherein the sub-display unit is provided on an exterior surface of the portable device.

14. The portable device as claimed in claim 12, further comprising:
an audio decoder to decode audio data output by the channel module,
wherein, when a selection signal for an audio channel is received via the control signal reception unit, the control unit controls the power supply unit to supply power to the audio decoder and controls the audio decoder to decode the audio data.

15. The portable device as claimed in claim 14, further comprising:
a switch; and
a video decoder to decode video streaming data included in the broadcasting signal and the EPG information output by the channel module and to transmit the decoded EPG information to the storage unit; wherein, when the main power of the portable device is turned off, the control unit controls the power supply unit to supply power to the video decoder, and when a selection signal for a channel including the video streaming data is received, via the control signal reception unit, and the switch indicates that the portable device is opened up, the control unit controls the power supply unit to supply power to the main display unit to display decoded video streaming data.

16. The portable device as claimed in claim 12, further comprising:
a video decoder to decode video streaming data included in the broadcasting signal and the EPG information output by the channel module and transmits the decoded EPG information to the storage unit,
wherein, when the main power of the portable device is turned off, the control unit controls the power supply unit to supply power to the video decoder.

17. The portable device as claimed in claim 16, further comprising:
a switch, wherein, when a selection signal for a channel including the video streaming data is received, via the control signal reception unit, and the switch indicates that the portable device is opened up, the control unit controls the power supply unit to supply power to the main display unit to display decoded video streaming data.

18. The portable device as claimed in claim 12, further comprising:
a switch, wherein, when a selection signal for a channel including the video streaming data is received via the control signal reception unit and the switch indicates that the portable device is opened up, the control unit controls the power supply unit to supply power to the main display unit to display decoded video streaming data.

19. The portable device as claimed in claim 12, further comprising a button unit comprising a plurality of buttons control buttons, which enables a user to manipulate a channel search and selection on the sub-display unit.

20. The portable device as claimed in claim 12, wherein the sub-display unit comprises a touch-screen, which enables a user to manipulate a channel search and selection on the sub-display unit.

21. A method of operating a portable device capable of receiving broadcasts which comprises a main display unit and a sub-display unit installed on an exterior of the portable device, the method comprising:
supplying power to one or more components of the portable device used to drive the sub-display unit when a main power of the portable device is turned off;
displaying channel search information on the sub-display unit to enable a user to select a channel from the channel search information displayed on the sub-display unit; and
supplying power to one or more components of the portable device used to process a broadcast signal received, via a selected channel.

22. The method as claimed in claim 21, further comprising:
controlling operations of the components used to output the broadcast signal received, via the chosen channel.

23. The method as claimed in claim 21, further comprising:
storing information of a broadcast requested to be scheduled for recording if a request for a scheduled recording of the broadcast is submitted with reference to the channel search information displayed on the sub-display unit.

24. The method as claimed in claim 23, further comprising:
submitting a scheduled recording confirmation request; and
displaying information regarding one or more broadcasts scheduled to be recorded on the sub-display unit.

25. The method as claimed in claim 21, further comprising:
submitting a scheduled recording confirmation request; and
displaying information regarding one or more broadcasts scheduled to be recorded on the sub-display unit.

26. The method as claimed in claim 21, wherein the supplying of the power to the one or more components of the portable device used to drive the sub-display unit when the main power of the portable device is turned off comprises supplying power to a tuner and the sub-display unit of the portable device.

27. The method as claimed in claim 21, wherein the supplying of the power to the one or more components of the portable device used to process the broadcast signal received, via the chosen channel comprises:
supplying power to an audio decoder to decode audio data when the signal received, via the chosen channel, comprises audio data;
supplying power to the main display unit and a video decoder to decode video data when the signal received, via the chosen channel, comprises video data; and
supplying power to the main display unit, the video decoder, and the audio decoder when the signal received, via the chosen channel, comprises audio and video data.

28. The method as claimed in claim 21, wherein the supplying of the power to the one or more components of the portable device used to process the broadcast signal received via the chosen channel comprises:
connecting the portable device to an external display unit;
supplying power to an audio decoder to decode audio data when the signal received via the chosen channel comprises audio data;
supplying power to the video decoder to decode video data when the signal received via the chosen channel comprises video data; and
supplying power to the video decoder and the audio decoder when the signal received via the chosen channel comprises audio and video data.

29. The method as claimed in claim 21, further comprising detecting whether the portable device is opened up, wherein when the portable device is opened up, the main display unit is rotated from a closed position to an open position relative to a main body of the portable device.

30. The method as claimed in claim 29, wherein the supplying of the power to the one or more components of the portable device used to process the broadcast signal received, via the chosen channel comprises:
supplying power to an audio decoder to decode audio data when the signal received via the chosen channel comprises audio data;
supplying power to the main display unit and a video decoder to decode video data when the signal received via the chosen channel comprises video data and the portable device is opened up;
supplying power to the main display unit, the video decoder, and the audio decoder when the signal received via the chosen channel comprises audio and video data and the portable device is opened up; and
supplying power to the audio decoder when the signal received via the chosen channel comprises audio and video data and the portable device is not opened up.

31. The method as claimed in claim 21, wherein the selecting of the channel from the channel search information displayed on the sub-display unit comprises manipulating buttons of a button unit of the portable device to select the channel.

32. A computer-readable medium encoded with the method of claim 21 implemented by a computer.
